(19) United States
(12) Patent Application Publication
(10) Pub. No.: US 2021/0004794 A1
(43) Pub. Date: Jan. 7, 2021

(54) METHOD AND SYSTEM FOR AUTOMATICALLY GENERATING PERSONALIZED SMART CONTRACTS

(71) Applicant: Wipro Limited, Bangalore (IN)

(72) Inventors: Senthil Kumar Kumaresan, Bangalore (IN); Afsal Marattil, Bengaluru (IN); Gurdeep Singh Virdi, Bangalore (IN); Sanjoy Paul, Sugar Land, TX (US)

(21) Appl. No.: 16/459,927

(22) Filed: Jul. 2, 2019

(51) Int. Cl. G06Q 20/38; G06F 16/2457; G06Q 30/06

(52) U.S. Cl. CPC G06Q 20/389; G06Q 30/0645; G06F 16/24578

(57) ABSTRACT

A method and device for automatically generating personalized smart contracts is disclosed. The method includes identifying a plurality of asset attributes associated with a current asset within a blockchain network. Each of the plurality of asset attributes are compared with each of a plurality of asset clusters to compute a cluster similarity score, when a plurality of assets within the blockchain network do not include the current asset. The method includes identifying an asset cluster that has the highest cluster similarity score and which is also above a predefined threshold. Similarity scores are then computed for each of the set of assets within the asset cluster. At least one asset from the set of assets is then identified based on the associated similarity scores. A current smart contract template is generated based on at least one smart contract template associated with the at least one asset.

### TECHNICAL FIELD

This disclosure relates generally smart contracts, and more particularly to method and device for automatically generating personalized smart contracts.

### BACKGROUND

With advent of Internet Of Things (IoT) and Blockchain, there has been an increasing trend of adoption of “Gig Economy of Machines.” IoT enabled devices may communicate with digital marketplaces to make autonomous decisions that could pave way for the above said trend. In the current scenario, assets are equipped to make decisions based upon a defined ruleset as defined in a smart contract by the asset owner. An asset may refer to any physical product, which may be used, such as, cars, laptops, houses, or machinery parts. Smart contracts refer to programmable entities that are programmed into an asset present in a Blockchain. Smart contracts include set of rules defined by the asset owner, under which the asset may be used by persons who bid for the asset. Smart contracts further allow negotiation and verification between the lender and the receiver, while also enabling transparent transactions without involving third parties. By way of an example, the asset owner may have defined the below smart contract for a rental use case. Analyze bids from digital marketplace and select lessee based upon maximum duration requested and maximum price. Based on this smart contract, the asset may be rented, if the rules set in the smart contract are satisfied.

Currently, these contracts are available in written languages as legal documents or agreements. However, as smart contracts, these written documents are converted as algorithm or self-executable codes. When the smart contract rules defined by the asset owner are met, these codes will be executed automatically and the person who bids for the asset may use it for the specified period as per the defined rules. There may be multiple scenarios in which an asset may be utilized, for example, in a rental market place or in a service market place. In the example of rental market place, the asset owner may set the rules for renting an asset. The rules may include, but are not limited to minimum bid per hour, criteria for bidding, qualifications for persons who can bid. Once these rules are defined by the asset owner, they are embedded inside the asset itself.

Further, while selecting the asset for usage, there may be two scenarios through which it may be done. In the first scenario, considering the rental market place example, the asset may publish itself as being available for renting. The lessees, who act as subscribers, may then receive notification about the asset based on which they may start bidding for the asset. In the second scenario, the lessees may be the publishers, who define the criteria based on which they prefer an asset and the asset act as subscribers. Based on the smart contract rules set by the owner, the asset has the intelligence inside it to decide a lessee who may use the asset for the next specified period.

In certain scenarios, creating a smart contract template may have different challenges. Firstly, the required smart contract template may differ depending on the type of asset. For example, the smart contract template required for a heavy equipment machinery, such as, a JCB may be different form a template required for a light equipment machinery, such as, a plate compactor. Therefore, the asset owner will not have access to or knowledge about the relevant smart contract template required for the asset. Secondly, the smart contract template may also change dynamically depending upon the context of usage of the asset, i.e., the smart contract template must be context aware and change dynamically based on the location of usage, person using it or type of asset used.

Thirdly, the intelligence to generate the required smart contract must be populated across different market places. For example, the smart contract template required for parts market place may be different from rental market place and service market place. Finally, once the initial template is created by the asset owner, the asset must be autonomous and generate more customized personal smart contracts for every transaction, which is not possible in any conventional system.

### SUMMARY

In one embodiment, a method for automatically generating personalized smart contracts is disclosed. The method includes identifying, by a smart contract creating device, a plurality of asset attributes associated with a current asset within a blockchain network. The method further includes comparing, by the smart contract creating device, each of the plurality of asset attributes with each of a plurality of asset clusters to compute a cluster similarity score for each of the plurality of asset clusters, when a plurality of assets within the blockchain network do not comprise the current asset. Each asset cluster within the plurality of asset clusters comprises a set of assets from the plurality of assets, and wherein each of the plurality of assets comprises an associated smart contract template. The method includes identifying, by the smart contract creating device, an asset cluster from the plurality of asset clusters, wherein the cluster similarity score for the asset cluster is the highest and is above a predefined threshold. The method further includes computing, by the smart contract creating device, similarity scores for each of the set of assets within the asset cluster, based on a comparison with the plurality of asset attributes of the current asset. The method includes identifying, by the smart contract creating device, at least one asset from the set of assets based on the associated similarity scores. The method further includes generating, by the smart contract creating device, a current smart contract template based on at least one smart contract template associated with the at least one asset.

In another embodiment, a smart contract creating device for automatically generating personalized smart contracts is disclosed, the smart contract creating device includes a processor and a memory communicatively coupled to the processor, wherein the memory stores processor instructions, which, on execution, causes the processor to identify a plurality of asset attributes associated with a current asset within a blockchain network. The processor instructions further causes the processor to compare each of the plurality of asset attributes with each of a plurality of asset clusters to compute a cluster similarity score for each of the plurality of asset clusters, when a plurality of assets within the blockchain network do not comprise the current asset. Each asset cluster within the plurality of asset clusters comprises a set of assets from the plurality of assets, and wherein each of the plurality of assets comprises an associated smart contract template. The processor instructions causes the processor to identify an asset cluster from the plurality of asset clusters. The cluster similarity score for the asset cluster is the highest and is above a predefined threshold. The processor instructions causes the processor to compute similarity scores for each of the set of assets within the asset cluster, based on a comparison with the plurality of asset attributes of the current asset. The processor instructions further causes the processor to identify at least one asset from the set of assets based on the associated similarity scores. The processor instructions causes the processor to generate a current smart contract template based on at least one smart contract template associated with the at least one asset.

In yet another embodiment, a non-transitory computer-readable storage medium is disclosed. The non-transitory computer-readable storage medium has stored thereon, a set of computer-executable instructions causing a computer comprising one or more processors to perform steps that include identifying a plurality of asset attributes associated with a current asset within a blockchain network; comparing each of the plurality of asset attributes with each of a plurality of asset clusters to compute a cluster similarity score for each of the plurality of asset clusters, when a plurality of assets within the blockchain network do not comprise the current asset, wherein each asset cluster within the plurality of asset clusters comprises a set of assets from the plurality of assets, and wherein each of the plurality of assets comprises an associated smart contract template; identifying an asset cluster from the plurality of asset clusters, wherein the cluster similarity score for the asset cluster is the highest and is above a predefined threshold; computing similarity scores for each of the set of assets within the asset cluster, based on a comparison with the plurality of asset attributes of the current asset; identifying at least one asset from the set of assets based on the associated similarity scores; and generating a current smart contract template based on at least one smart contract template associated with the at least one asset.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram illustrating a system for automatically generating personalized smart contracts using distributed ledger, in accordance with an embodiment.

FIG. 2 is a block diagram illustrating a smart contract creating device with modules located within an edge device and a cloud, in accordance with an embodiment.

FIG. 3 illustrates a flowchart of a method for automatically generating personalized smart contracts, in accordance with an embodiment.

FIG. 4 illustrates a flowchart of a method for identifying one or more assets from a set of assets within an asset category, in accordance with an embodiment.

FIGS. 5A and 5B illustrate a flowchart of a method for automatically generating personalized smart contracts in different scenarios, in accordance with an embodiment.

FIG. 6 illustrates an asset domain ontology that includes an ontology tree and associated smart contract templates, in accordance with an exemplary embodiment.

FIG. 7 illustrates a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

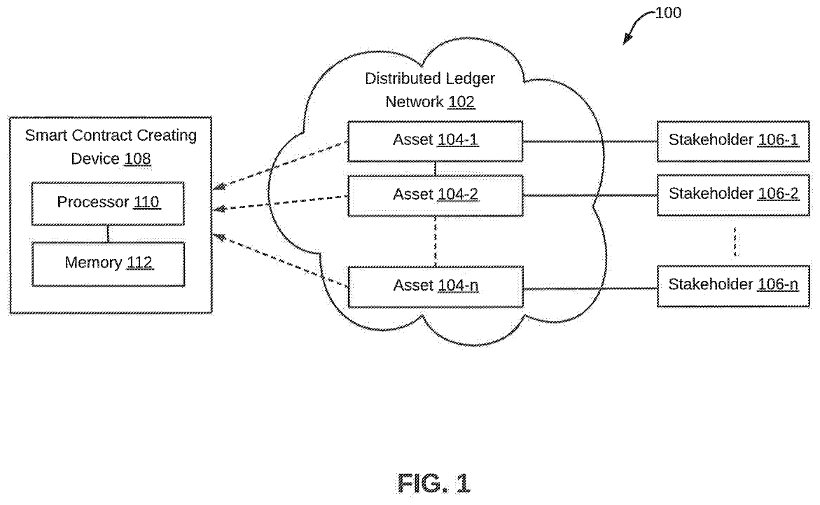

FIG. 1 is a system 100 for automatically generating personalized smart contracts using a distributed ledger network 102, in accordance with an embodiment. The system 100 may enable generation of personalized smart contracts using the distributed ledger network 102. The distributed ledger network 102, for example, may be a blockchain network or a Hashgraph network. The distributed ledger network 102 may include assets 104-1 to 104-n, collectively referred to as a plurality of assets 104. Each of the plurality of assets 104 may be associated with a distributed ledger. Examples of the plurality of assets may include, but are not limited to heavy equipment (for example, JCB, dozers, loaders, graders, excavators, scrapers, backhoes, cranes-draglines, forklifts, manlifts, compactors/rollers, cable plows, American augers, mixers, and heavy haul trucks), process manufacturing machine, discrete manufacturing machines (for example, injection, blow, PET or Thermoforming machines), household electronic assets (for example, refrigerators, chillers, televisions, washing machines, pharmaceutical manufacturing machines, power grids, transformers, electrical charging stations, automobiles, and parking stations. In other words, plurality of assets may include any physical object or space or any item that may be commercialized or traded.

The system 100 enables automatic generation of smart contracts (which are dynamic) using historical data and prediction of future events associated with the plurality of assets 104. The system 100 may additionally employ the techniques of Internet of Things (IoT). In other words, each of the plurality of assets 104 may be IoT enabled. Thus, the system 100 may employ continuous and remote monitoring of the plurality of assets 104 using the techniques of IoT. Each of the plurality of assets 104 may have various IoT sensors installed in order to monitor various parameters. Thus, IoT sensors of a given asset may store information associated with it on the associated distributed ledger. As a result, the system 100 generates context aware smart contracts, each of which is unique to a particular transaction.

The requirements and context for a particular transaction may be provided by one of stakeholders 106-1 to 106-n, collectively referred to as a plurality of stakeholders 106. By way of an example, the stakeholder 106-1 may be associated with the asset 104-1 and the stakeholder 106-n may be associated with the asset 104-n. The requirements, for example, may include, but are not limited to rental, sale, service, or exhibition. The system 100 may include multiple marketplaces (not shown in FIG. 1) associated with each such requirement. The context, for example, may include, but are not limited to location of usage, person using it, or a type associated with an asset.

In order to automatically generate personalized smart contracts, the system 100 may include a smart contract creating device 108, which may reside in each of the plurality of assets 104. The smart contract creating device 108, for example, may be one of, but is not limited to an application server, a laptop, a desktop, a smartphone, or a tab. The smart contract creating device 108 may also be implemented in the form of a distributed system. In an embodiment, the smart contract creating device 108 may reside remotely from the plurality of assets and may be communicatively coupled to the distributed ledger network 102 via a network (not shown in FIG. 1). The smart contract creating device 108 may thus be able to access information stored in the distributed ledger network 102. The network may be a wired or a wireless network and the examples may include, but are not limited to the Internet, Wireless Local Area Network (WLAN), Wi-Fi, Long Term Evolution (LTE), Worldwide Interoperability for Microwave Access (WiMAX), and General Packet Radio Service (GPRS).

The distributed ledger network 102 may include a continuously growing list of interlinked records called a distributed ledger exchanged between the plurality of assets 104. The records in the distributed ledger may be secured through cryptography, such that the records cannot be modified or tampered with. The distributed ledger may record transactions between two parties in a verifiable and permanent way. Accordingly, the distributed ledger network 102 may permanently record each communication received from the plurality of stakeholders 106. This information may later be accessed by the smart contract creating device 108. When the distributed ledger network 102 is a Blockchain network, data storage may use a single Blockchain platform or multiple Blockchain platforms. In this case, a Blockchain Bridge may handle these multiple Blockchain platforms.

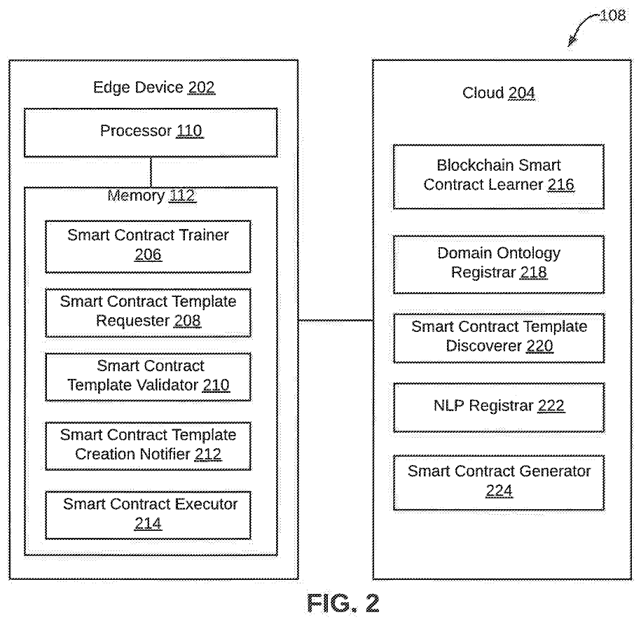

The smart contract creating device 108 may further include a processor 110 that may be communicatively coupled to a memory 112. The memory 112 stores processor instructions, which on execution cause the processor 110 to automatically generate personalized smart contracts using the distributed ledger network 102. The memory 112 may be a non-volatile memory or a volatile memory. Examples of the non-volatile memory, may include, but are not limited to a flash memory, a Read Only Memory (ROM), a Programmable ROM (PROM), Erasable PROM (EPROM), and Electrically EPROM (EEPROM) memory. Examples of the volatile memory may include, but are not limited Dynamic Random Access Memory (DRAM), and Static Random-Access memory (SRAM). The memory 112 may further include various modules, which are explained in detail in conjunction with FIG. 2.

The system 100 provides multiple advantages to asset owners, Original Equipment Manufacturers (OEM), dealers or any other stakeholders associated with the plurality of assets 104. The advantages include creation of a gig economy for machines to maximize asset utilization potential, increase efficiency in the way the plurality of assets 104 collaborate with service providers, enable a trustful environment in the way businesses are executed, thereby making the plurality of assets 104 completely independent and intelligent.

Referring to FIG. 2, a block diagram illustrating the smart contract creating device 108 with modules located within an edge device 202 and a cloud 204, in accordance with an embodiment. The edge device 202 may be an edge node or an edge gateway. The smart contract creating device 108 is configured to automatically generate personalized smart contracts using the distributed ledger network 102. The block diagram of FIG. 2 may represent implementation of the smart contract creating device 108 as a distributed system, such that, few modules within the smart contract creating device 108 are located on the edge device 202, while other are located on the cloud 204. It will be apparent to a person skilled in the art that the smart contract creating device 108 may be completely located within the edge device 202 or within the cloud 204. The code for the edge device 202 may run on any system, without any limitations, for example, an industrial personal computer or a laptop. The other part of the smart contract creating device 108 is on the cloud, which has components of an IoT platform and a Blockchain platform.

The edge device 202 may include the processor 110 and the memory 112 disclosed in the FIG. 1. The memory 112 may include a smart contract trainer 206, a smart contract template requester 208, a smart contract template validator 210, a smart contract template creation notifier 212, and a smart contract executor 214. The cloud 204 may include a blockchain smart contract learner 216, a domain ontology registrar 218, a smart contract template discoverer 220, a Natural Language processor (NLP) registrar 222, and a smart contract generator 224.

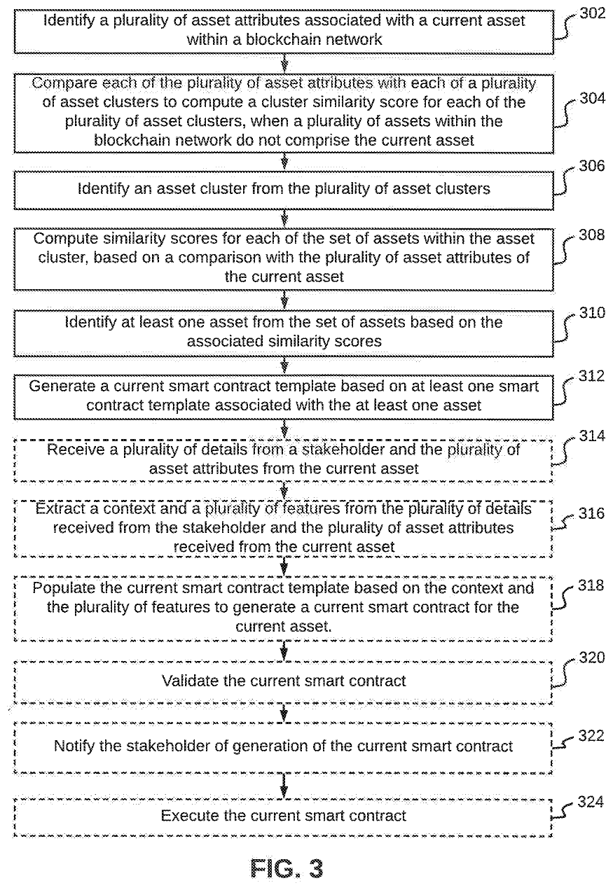

The smart contract trainer 206 sends real time information associated with an asset, has the ability for edge intelligence to make some real time analytics or trigger other smart contract based workflows. The smart contract trainer 206 also forwards historical data associated with the asset in batches to the cloud 204, in order to train the smart contract creating device 108 to generate personalized smart contracts. This is further explained in detail in conjunction with FIG. 3.

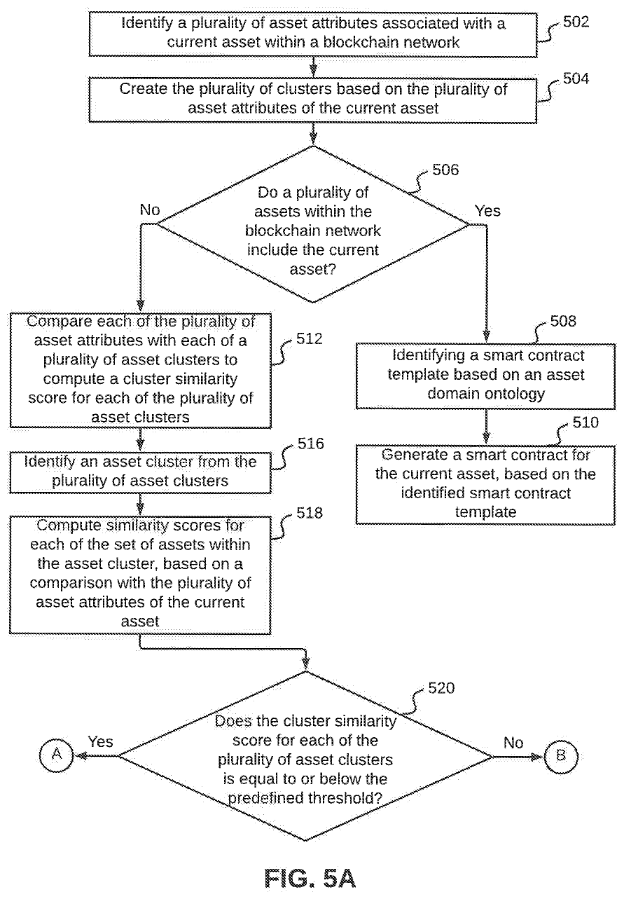

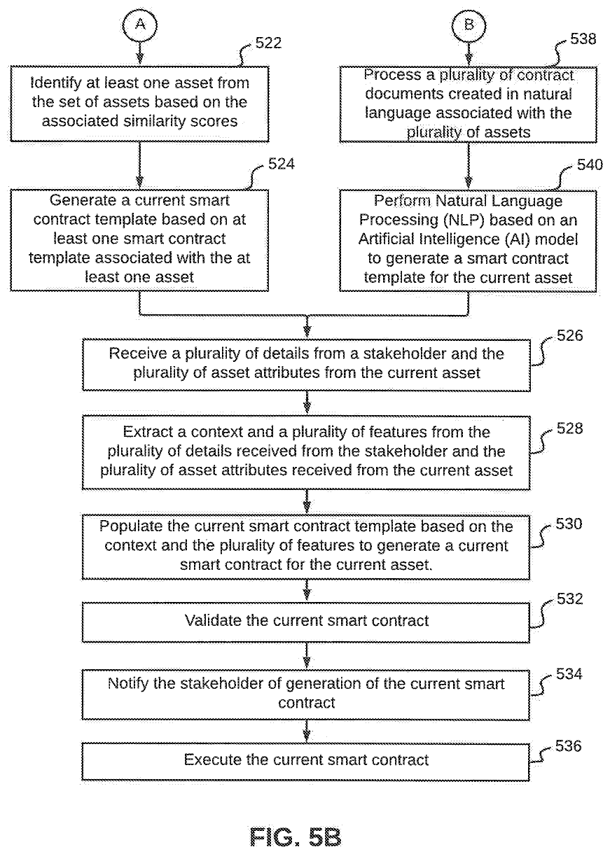

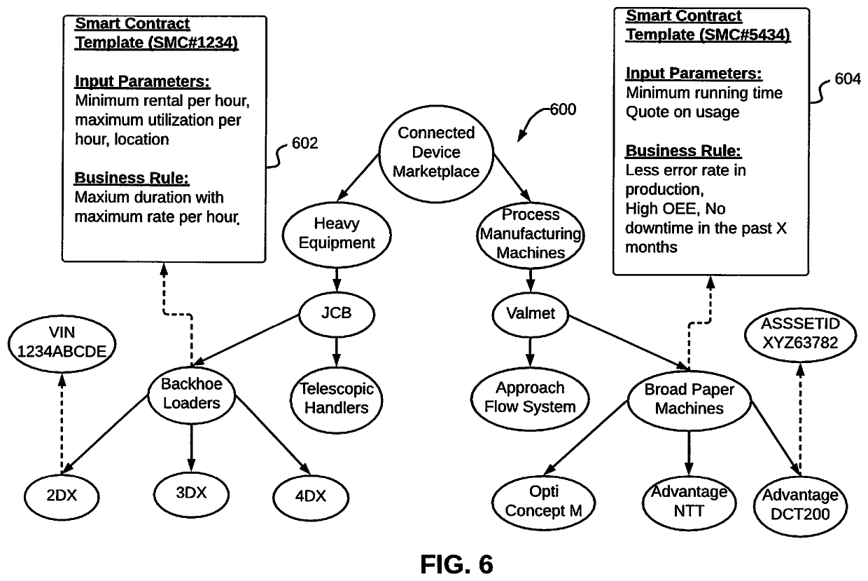

The smart contract template requester 208 triggers generation of smart contracts by requesting smart contract form the domain ontology registrar 218, which is configured to generate smart contract templates based upon an asset domain ontology that is fed into the smart contract creating device 108. This is further explained in detail in conjunction with FIGS. 5A, 5B, and 6. The smart contract template validator 210 is configured to validate the smart contract after generation. Once the personalized smart contract template is generated, the smart contract templates are validated to examine if the generated templates suits the asset and/or asset owner. This is further explained in detail in conjunction with FIG. 3. The smart contract template creation notifier 212 is configured to notify the asset and/or the asset owner or the concerned stakeholder on generation of a new smart contracts (which are dynamic and peer to peer) for a particular business need. The smart contract executor 214 then executes the generated smart contract in the asset. This is further explained in detail in conjunction with FIG. 3.

The blockchain smart contract learner 216 receives the real time information of the asset from the smart contract trainer 206 in order to learn the nature of assets and trigger generation of personalized smart contracts. The smart contract template discoverer 220 is configured to skim through similar assets to find out relevant smart contract templates in absence of a direct smart contract templates based upon asset domain ontology, This is further explained in detail in conjunction with FIG. 3.

In absence of smart contract templates based upon asset domain ontology, the NLP registrar 222 is configured to create smart contract templates based on machine learning techniques from generalized English agreement copies associated with similar assets. The NLP approach may be traditional or deep learning based. This is further explained in detail in conjunction with FIGS. 5A and 5B. The smart contract generator 224 is configured to replace the smart contract template with actual values that are dynamic and are based upon context, for example, usage or location. The smart contracts thus generated are context aware, dynamic, and personalized based on the end stakeholder. This is further explained in detail in conjunction with FIGS. 3, 5A and 5B.

Referring to FIG. 3, a flowchart of a method for automatically generating personalized smart contracts is illustrated, in accordance with an embodiment. At step 302, the smart contract creating device 108 identifies a plurality of asset attributes associated with a current asset within a blockchain network. The current asset may be an asset that has been on-boarded by a stakeholder (who may be an asset owner). The current asset, for example, may include but is not limited to heavy equipment (for example, JCB, dozers, loaders, graders, excavators, scrapers, backhoes, cranes-draglines, forklifts, manlifts, compactors/rollers, cable plows, American augers, mixers, and heavy haul trucks), process manufacturing machine, discrete manufacturing machines (for example, injection, blow, PET or Thermoforming machines), household electronic assets (for example, refrigerators, chillers, televisions, washing machines, pharmaceutical manufacturing machines, power grids, transformers, electrical charging stations, automobiles, and parking stations. In other words, plurality of assets may include any physical object or space or any item that may be commercialized or traded.

The plurality of asset attributes may include but are not limited to make of the asset, a model of the asset, an asset category associated with the asset, rental rates associated with the asset, utilization of the asset, maximum speed attainable by the asset, maximum Rounds Per Minute (RPM) attainable by the asset, number of cycles associated with the asset, and a location of the asset. In an embodiment, the plurality of asset attributes is the real time information of current asset, which is monitored using IoT and is forwarded to the blockchain network in order to perform some real time analytics. The monitored real time information may include, but is not limited to current information and historical data associated with the current asset, which may be used to train the smart contract creating device 108 to generate personalized smart contracts.

The blockchain network further includes a plurality of assets, such that, each of the plurality of assets include an associated smart contract template. Moreover, each of the plurality of assets act as nodes within the blockchain network. Information associated with each of the plurality of assets (for example, associated stakeholders and asset attributes) may be stored in an asset knowledge database. When information regarding the current assets is received by the blockchain network, it is determined whether the plurality of assets already includes the current asset (or same asset with same asset attributes) or not. When the blockchain network already includes the current asset (or same asset with same asset attributes), an asset domain ontology may be used to identify a smart contract template for the current asset. This is further explained in detail in conjunction with FIGS. 5A and 5B.

However, when the plurality of assets do not include the current asset, the smart contract creating device 108, at step 304, compares each of the plurality of asset attributes of the current asset with each of a plurality of asset clusters to compute a cluster similarity score for each of the plurality of asset clusters. In other words, when the current asset (or same asset with same asset attributes) is not already a part of the blockchain network, a cluster similarity score for each asset cluster with respect to the current asset is computed. The cluster similarity score may be determined using established techniques, for example, but not limited to collaborative filtering or association rule mining. In an embodiment, for a given asset cluster, a cluster similarity score may be computed for the given asset cluster by comparing the keywords associated with the plurality of assets attributes of the current asset with the keywords associated with the given asset cluster. The cluster similarity score may be derived based on the number of matching keywords.

Each asset cluster within the plurality of asset clusters includes a set of assets from the plurality of assets. For a given cluster, the constituent set of assets are identified based on asset attributes associated with the constituent set of assets. In other word, assets within the constituent set of assets have similar attributes. By way of an example, an asset cluster may include assets from a particular manufacturer and another asset cluster may include a given type of assets that have similar attainable RPM. By way of another example, separate asset clusters may be created for heavy equipment machinery for construction/digging or injection molding machine to generate Polyethylene Terephthalate (PET) bottles, It will be apparent to a person skilled in the art that a given asset may be include into more than one asset cluster.

In an embodiment, since information associated with the plurality of assets is available in the asset knowledge database, the plurality of assets may be grouped into various asset clusters based on information in the asset knowledge database. This classification of assets may be made based on standard techniques, for example, association rule mining or by any of the other supervised learning techniques. In a scenario where an asset does not have any intelligence or recommendation to suggest, the asset may communicate with modules (located on the cloud) within the smart contract creating device 108. The smart contract creating device 108 may then determine an appropriate asset cluster for the asset.

In another embodiment, the plurality of asset clusters may be created based on the plurality of asset attributes of the current asset. By way of an example, the plurality of asset attributes of the current asset may include a model of the current asset, rental rates associated with the current asset, and a location of the asset. Thus, in this case, multiple asset clusters may be created, such that, these asset clusters are based on asset models, different rental rates associated with the assets, and location associated with the assets.

At step 306, the smart contract creating device 108 identifies an asset cluster from the plurality of asset clusters. The cluster similarity score for the asset cluster is the highest, when compared with cluster similarity scores computed for other asset clusters, Additionally, the cluster similarity score is above a predefined threshold. However, when the cluster similarity score is below or equal to the predefined threshold, the smart contract creating device 108 processes a plurality of contract documents created in natural language and associated with the plurality of assets. Thereafter, in response to the processing, Natural Language Processing (NLP) is performed based on an Artificial Intelligence (Al) model to generate a smart contract template for the current asset. This is further explained in detail in conjunction with FIGS. 5A and 5B.

Once the asset cluster has been identified, at step 308, the smart contract creating device 108 computes similarity scores for each of the set of assets within the asset cluster. The similarity scores are computed based on a comparison of the plurality of asset attributes of the current asset with asset attributes associated with each asset within the asset cluster. In an embodiment, techniques like collaborative filtering may be used to determine the similarity scores. Thus, once the asset cluster has been identified, the smart contract creating device 108 starts to evaluate smart contract templates within the asset cluster so identified.

At step 310, the smart contract creating device 108 identifies one or more assets from the set of assets based on the associated similarity scores. In an embodiment, assets within the set of assets may be ranked based on the computed similarity scores. Thereafter, the one or more assets may be selected, such that, ranks associated with the one or more assets are above a predefined threshold rank. In an embodiment, the one or more assets may be identified, such that, similarity scores for the one or more assets are above a score threshold. In another embodiment, only one asset may be selected from the set of assets, such that, the selected asset has the highest rank or the highest similarity score. This is further explained in detail in conjunction with FIG. 5. At step 312, the smart contract creating device 108 generates a current smart contract template based on one or more smart contract templates associated with the one or more assets identified at step 310. When only one asset is identified at step 310, the smart contract template associated with this single asset may be used to generate the smart contract template for the current asset. Thus, based on the relevance and ranking criteria, a more relevant smart contract template is generated for the current asset.

Thus, in this embodiment, when a new asset is on-boarded by an asset owner (stakeholder), a required smart contract template may be identified from a similar asset within the blockchain network. As discussed above, similar assets may be identified by using established techniques such as collaborative filtering or association rule mining. To this end, an asset category is identified by traversing through the plurality of asset categories, based on various asset attributes of the current asset, for example, asset type, industry. As a result, a more relevant smart contract template that is required for the asset is identified.

In an exemplary embodiment, the following pseudo-code may be used to generate the

Find SmartContractDiscovery(Asset ID) {

Read AssetID in a Asset_Class
Read Assetcategory in a Asset_Class
Find AssetContextInformation in a Asset_Class
Cluster C1 = ReturnCluster (Asset_Class);
ArrayofAssets AssetsinCluster = FindAssetsinCluster (Cluster C1);
For each ArrayofAsset AssetinCluster
ArrayofSmartContractTemplate SCTemplate = Call

(SmartContractTemplate(AssetID);
RecommendedTemplate = BestRankingofRecommendedTemplate(SCTemplate
);
}

At step 314, the smart contract creating device 108 may receive a plurality of details from the stakeholder of the current in addition to the plurality of asset attributes from the current asset. At step 316, the smart contract creating device 108 extracts a context and a plurality of features from the plurality of details received from the stakeholder and the plurality of asset attributes received from the current asset. At step 318, the smart contract creating device 108 populates the current smart contract template based on the context and the plurality of features to generate a current smart contract for the current asset. As a result, after generation of the smart contract template, the smart contract creating device 108 fills in the recommended values for each of the parameters that is very specific to each transaction, context, asset and stakeholder. Thus, context aware, dynamic, and personalized smart contract is generated. By way of this method, it is not only possible to generate smart contract templates, but also pre-fill values for each of these smart contract templates based on stakeholders involved, location of asset usage, or any other asset attribute. Based upon involvement of a stakeholder in a transaction, location of asset usage, or any other asset attribute, an asset is provided the ability to generate a more dynamic and personalized smart contract for every transaction.

Once the smart contract templates are generated, at step 320, the smart contract creating device 108 validates the current smart contract in order to verify if the created smart contract template suits the current asset as well as the stakeholder (asset owner). Thereafter, at step 322, the smart contract creating device 108 notifies the current asset as well as the asset owner regarding generation of the current smart contract. At step 324, the smart contract creating device 108 executes the current smart contract.

As a result of the above discussed methods, it is not only possible to generate the smart contract templates, but also pre-fill values for each of these smart contract templates. Till generation of a smart contract template, values for relevant parameters (example, Utilization) may be provided. But, during population of the smart contract template, it is possible to pinpoint the exact utilization value in the smart contract based upon the end stakeholder. By way of an example, for a user A, the utilization may be prefilled as 8 hours, because past usage for the user A indicated that he has not abused the asset. By way of another example, for a user B, the utilization may be prefilled as 4 hours only, because past usage of the user B may indicate that he has abused the asset and has used the asset in tough terrain conditions.

Based upon stakeholders involved in a transaction, an asset may have the ability to generate a more dynamic and personalized smart contract for every transaction. By way of an example, the maximum asset utilization term for a user A may be 8 hours since the user A may have used the asset in a less hazardous zone. Whereas, the maximum utilization term for the same asset to a user B may be only 6 hours, since the user B has used the asset in a hazardous area where the temperature is high and/or terrain is difficult. Therefore, based on the context (such as stakeholders involved, location, usage, etc.), the smart contracts may be generated dynamically.

To this end, user context may be extracted based on all transactions made by the user for given asset as well as other assets. A model may be created for every user, which enables determination of the user category as one of low risk, medium risk or high risk. The user categories may be completely adaptable and may depend upon a target business area. Based on the extracted user content, a smart contract may be generated that is more personalized for the user.

In a similar manner, personalization is carried out an asset level to provide recommended smart contract template for a specific asset. To this end, features of the asset are deduced and a model is created that provides an asset category. The categories are completely adaptable and may depend upon the target business areas. Based on the categorization of the asset and the deduced asset information, smart contract template parameters are recommended for the specific asset. The above details are used to provide a more personalized, dynamic and deployable smart contract that is unique for an asset, a user, and a transaction.

The smart contract creating device 108 may be implemented in multiple marketplace and may enable assets to manage multiple marketplaces, for example, but not limited to a rental marketplace, a service marketplace, or an insurance marketplace. In such multiple marketplace scenarios, marketplace details may also be taken as an input to provide a deployable smart contract that is unique for an asset, a user a transaction, and a marketplace.

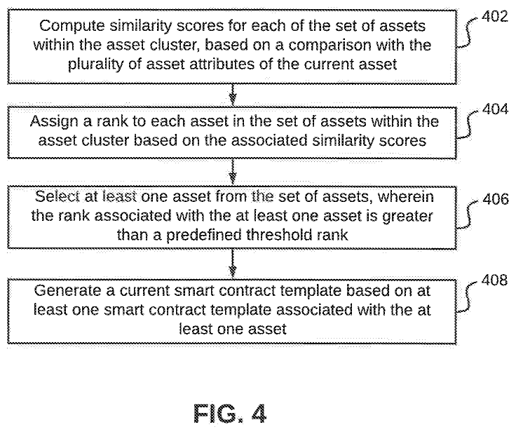

Referring now to FIG. 4, a flowchart of a method for identifying one or more assets from a set of assets within an asset category, in accordance with an embodiment. At step 402, similarity scores are computed for each of the set of assets within the asset cluster. The similarity scores are computed based on a comparison of asset attributes of each of the set of assets with the plurality of asset attributes of the current asset. Based on the associated similarity scores, a rank to each asset in the set of assets within the asset cluster, at step 404. At step 406, one or more assets from the set of assets is selected, such that, the rank associated with the one or more assets is greater than a predefined threshold rank. Thereafter, at step 408, a current smart contract template is generated based on one or more smart contract templates associated with the one or more assets. This has already been explained in detail in conjunction with FIG. 3.

Referring now to FIGS. 5A and 5B, a flowchart of a method for automatically generating personalized smart contracts in different scenarios is illustrated, in accordance with an embodiment. At step 502, the smart contract creating device 108 identifies a plurality of asset attributes associated with a current asset within a blockchain network. The current asset may be an asset that has been on-boarded by a stakeholder (who may be an asset owner). The current asset, for example, may include but is not limited to heavy equipment (for example, JCB, dozers, loaders, graders, excavators, scrapers, backhoes, cranes-draglines, forklifts, manlifts, compactors/rollers, cable plows, American augers, mixers, and heavy haul trucks) and process manufacturing machine.

In addition to the plurality of asset attributes associated with the current asset, additional details that may include a unique Identifier (ID) of the current asset, a parent asset category for the current asset, stakeholder (owner or lessee) associated with the current asset, or profile of the stakeholder. Additional details may also include information associated with accessories that the asset may take or sub-components of the asset that may provide a separate service. Such additional details may be obtained by way of IoT enabled assets.

At step 504, a plurality of clusters may be created based on the plurality of asset attributes of the current asset. This has already been explained in detail in conjunction with FIG. 3. At step 506, a check is performed to determine whether a plurality of assets within the blockchain network include the current asset. Each of the plurality of assets include an associated smart contract template. Moreover, each of the plurality of assets act as nodes within the blockchain network. Information associated with each of the plurality of assets (for example, associated stakeholders and asset attributes) may be stored in an asset knowledge database. When information regarding the current assets is received by the blockchain network, it is determined whether the plurality of assets already include the current asset (or same asset with same asset attributes) or not.

If the plurality of assets include the current asset (or in other words, the current asset (or same asset with same asset attributes) is already present in the blockchain network) a smart contract template is identified based on an asset domain ontology at step 508. To this end, the plurality of asset attributes along with the addition details described above may be mapped to a rule engine or template registry to find out best possible smart contract template for the current asset. The asset domain ontology includes an ontology tree for the plurality of assets along with smart contract templates associated with each of the plurality of assets. An exemplary asset domain ontology is depicted in conjunction with FIG. 6. In an embodiment, a proprietary modelling framework (by way of the asset domain ontology) may be used to suggest a smart contract template for the current asset. This is especially required when owner of the current asset is clueless about the required smart contract template. Based on the identified smart contract template, a smart contract is generated for the current asset at step 510.

The modelling framework, i.e., the asset domain ontology, is a semantic data model based smart contract definition that includes a complete system including different asset categories and asset variants/product classes. An asset variant/product class refers to different types of assets present under an asset category. For every asset variant/product class, a smart contract template is designed based on the monitoring of different data items. Thus, a customized data template can be generated for every asset type and embedded inside the asset in order to provide template suggestions to the asset owner as needed. Once the template suggestions are provided, the asset owner may use the template and customize it as per the transaction and need.

Thus, an asset domain ontology based smart contract registrar is triggered to create smart contract templates from already available smart contract templates that are mapped against asset categories based on asset type and asset specific context for the current asset. Customized smart contract templates are already generated for every asset type and embedded inside the asset category in the asset domain ontology. Based on cross-intelligence data, a smart contract template suggestion from the available smart contract templates is provided as per the need of the asset owner based on asset parameter and asset category context. The asset owner can customize the suggested smart contract template as per current requirements.

Referring back to step 506, when the plurality of assets in the blockchain do not include the current asset (or same asset with same asset attributes), steps 512 to step 518 are performed. These steps are analogous to steps 304 to 308, which have already been explained in detail in conjunction with FIG. 3. Thereafter, at step 520, a check is performed to determine whether the cluster similarity score computed for each of the plurality of asset clusters is equal to or below the predefined threshold. When the cluster similarity score for each of the plurality of asset clusters is above the predefined threshold, steps 522 to 536 are performed. These steps are analogous to steps 310 to 324, which have already been explained in detail in conjunction with FIG. 3.

Referring back to step 520, when the cluster similarity score computed for each of the plurality of asset clusters is equal to or below the predefined threshold, at step 538, a plurality of contract documents created in natural language associated with the plurality of assets are processed. Thereafter, in response to the processing, at step 540, NLP is performed based on an AI model to generate a smart contract template for the current asset. In an embodiment, the smart contract creating device 108 may use existing and traditional approach or may even use advanced deep learning techniques in order to generate the smart contract template.

Thus, in this case, the smart contract creating device 108 may skim through English based contracts from other assets anchored in the Blockchain network to recommend a smart contract template for the current asset. The smart contract creating device 108 then starts mining those data to deduce information in order to generate the smart contract template. By way of an example, in case of an English based contract, the system may include a NLP to deduce data, such as. the contract template, contract industry, definition of contract, or asset type, and use that data for next level of analysis. Based on this further analysis, the required smart contract template may be generated or suggested to the stakeholder associated with the asset (the asset owner). After performing the step 540, the steps 526 to 536 are performed.

As a result of the above discussed methods, it is not only possible to generate the smart contract templates, but also pre-fill values for each of these smart contract templates. Till generation of a smart contract template, values for relevant parameters (example, Utilization) may be provided. But, during population of the smart contract template, it is possible to pinpoint the exact utilization value in the smart contract based upon the end stakeholder. By way of an example, for a user A, the utilization may be prefilled as 8 hours, because past usage for the user A indicated that he has not abused the asset. By way of another example, for a user B, the utilization may be prefilled as 4 hours only, because past usage of the user B may indicate that he has abused the asset and has used the asset in tough terrain conditions.

Based upon stakeholders involved in a transaction, an asset may have the ability to generate a more dynamic and personalized smart contract for every transaction. By way of an example, the maximum asset utilization term for a user A may be 8 hours since the user A may have used the asset in a less hazardous zone. Whereas, the maximum utilization term for the same asset to a user B may be only 6 hours, since the user B has used the asset in a hazardous area where the temperature is high and/or terrain is difficult. Therefore, based on the context (such as stakeholders involved, location, usage, etc.), the smart contracts may be generated dynamically.

In a similar manner, personalization is carried out an asset level to provide recommended smart contract template for a specific asset. To this end, features of the asset are deduced and a model is created that provides an asset category. The categories are completely adaptable and may depend upon the target business areas. Based on the categorization of the asset and the deduced asset information, smart contract template parameters are recommended for the specific asset, The above details are used to provide a more personalized, dynamic and deployable smart contract that is unique for an asset, a user, and a transaction.

The smart contract creating device 108 may be implemented in multiple marketplace and may enable assets to manage multiple marketplaces, for example, but not limited to a rental marketplace, a service marketplace, or an insurance marketplace. In such multiple marketplace scenarios, marketplace details may also be taken as an input to provide a deployable smart contract that is unique for an asset, a user a transaction, and a marketplace.

Referring now to FIG. 6, an asset domain ontology that includes an ontology tree 600 and associated smart contract templates is illustrated, in accordance with an exemplary embodiment. The ontology tree 600 depicts mapping of various assets and asset categories with specific relationship or labels amongst each other. In an embodiment, the ontology tree 600 may be a graph representation or relational representation with simple or complex business rules against industry type or domain or asset category. By way of an example, the backhoe loader asset category has three sub-categories of asset category, i.e., 2DX, 3DX, 4DX. An asset of a specific type is mapped to an asset variant and smart contract template may be mapped against an asset or an asset category. Thus, when a new asset is being added, the smart contract creating device 108 checks parent asset category of the new asset and finds out if there are any smart contract templates mapped against that parent asset category. If so, that smart contract template is picked up by the smart contract creating device 108 as the “recommended smart contract template.”

In an exemplary embodiment, a pseudo-algorithm to identify a smart contract template using the ontology tree 600 is depicted below:

Find SmartContractTemplate(Asset ID) {

Read AssetID
Traverse through graph & determine the parent asset category

Check If Smart Contract Template Exists
If (exists)

Return as Smart Contract Template

Else { return;}

}
}

Additionally, in FIG. 6, a smart contract template 602 associated with the asset category of backhoe loader and a smart contract template 604 associated with the asset category of broad paper machines is depicted. Each of the smart contract templates 602 and 604 include input parameters and business rules.

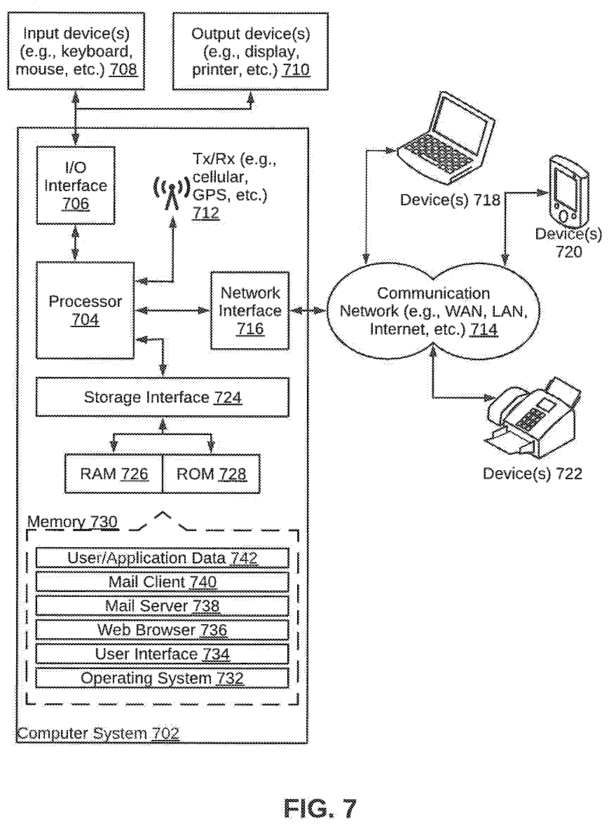

FIG. 7 is a block diagram of an exemplary computer system for implementing various embodiments. Computer system 702 may include a central processing unit (“CPU” or “processor”) 704. Processor 704 may include at least one data processor for executing program components for executing user- or system-generated requests. A user may include a person, a person using a device such as such as those included in this disclosure, or such a device itself. Processor 704 may include specialized processing units such as integrated system (bus) controllers, memory management control units, floating point units, graphics processing units, digital signal processing units, etc. Processor 704 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. Processor 704 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 704 may be disposed in communication with one or more input/output (I/O) devices via an I/O interface 706. I/O interface 706 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video. VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 706, computer system 702 may communicate with one or more I/O devices. For example, an input device 708 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 710 may be a printer, fax machine, video display (e.g., cathode ray tube (CRT), liquid crystal display (LCD), light-emitting diode (LED), plasma, or the like), audio speaker, etc. In some embodiments, a transceiver 712 may be disposed in connection with processor 704. Transceiver 712 may facilitate various types of wireless transmission or reception. For example, transceiver 712 may include an antenna operatively connected to a transceiver chip (e.g., TEXAS® INSTRUMENTS WILINK WL1283® transceiver, BROADCOM® BCM4550IUB8® transceiver, INFINEON TECHNOLOGIES® X-GOLD 618-PMB9800® transceiver, or the like), providing IEEE 802.11a/b/g/n, Bluetooth, FM, global positioning system (GPS), 2G/3G HSDPA/HSUPA communications, etc.

In some embodiments, processor 704 may be disposed in communication with a communication network 714 via a network interface 716. Network interface 716 may communicate with communication network 714. Network interface 716 may employ connection protocols including, without limitation, direct connect, Ethernet (e.g., twisted pair 50/500/5000 Base T), transmission control protocol/internet protocol (TCP/IP), token ring, IEEE 802.11a/b/g/n/x, etc. Communication network 714 may include, without limitation, a direct interconnection, local area network (LAN), wide area network (WAN), wireless network (e.g., using Wireless Application Protocol), the Internet, etc. Using network interface 716 and communication network 714, computer system 702 may communicate with devices 718, 720, and 722. These devices may include, without limitation, personal computer(s), server(s), fax machines, printers, scanners, various mobile devices such as cellular telephones, smartphones (e.g., APPLE® IPHONE® smartphone, BLACKBERRY® smartphone, ANDROID® based phones, etc.), tablet computers, eBook readers (AMAZON® KINDLE® ereader, NOOK® tablet computer, etc.), laptop computers, notebooks, gaming consoles (MICROSOFT® XBOX® gaming console, NINTENDO® DS® gaming console, SONY® PLAYSTATION® gaming console, etc.), or the like. In some embodiments, computer system 702 may itself embody one or more of these devices.

In some embodiments, processor 704 may be disposed in communication with one or more memory devices (e.g., RAM 726, ROM 728, etc.) via a storage interface 724. Storage interface 724 may connect to memory 730 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 730 may store a collection of program or database components, including, without limitation, an operating system 732, user interface application 734, web browser 736, mail server 738, mail client 740, user/application data 742 (e.g., any data variables or data records discussed in this disclosure), etc. Operating system 732 may facilitate resource management and operation of computer system 702. Examples of operating systems 732 include, without limitation, APPLE® MACINTOSH® OS X platform, UNIX platform, Unix-like system distributions (e.g., Berkeley Software Distribution (BSD), FreeBSD, NetBSD, OpenBSD, etc.), LINUX distributions (e.g., RED HAT®, UBUNTU®, KUBUNTU®, etc.), IBM® OS/2 platform, MICROSOFT® WINDOWS® platform (XP, Vista/7/8, etc.), APPLE® IOS® platform, GOOGLE® ANDROID® platform, BLACKBERRY® OS platform, or the like. User interface 734 may facilitate display, execution, interaction, manipulation, or operation of program components through textual or graphical facilities. For example, user interfaces may provide computer interaction interface elements on a display system operatively connected to computer system 702, such as cursors, icons, check boxes, menus, scrollers, windows, widgets, etc. Graphical user interfaces (GUIs) may be employed, including, without limitation, APPLE® Macintosh® operating systems' AQUA® platform, IBM® OS/2 platform, MICROSOFT® WINDOWS® platform (e.g., AERO® platform, METRO® platform, etc.), UNIX X-WINDOWS, web interface libraries (e.g., ACTIVEX® platform, JAVA® programming language, JAVASCRIPT® programming language, AJAX® programming language, HTML, ADOBE® FLASH® platform, etc.), or the like.

In some embodiments, computer system 702 may implement a web browser 736 stored program component. Web browser 736 may be a hypertext viewing application, such as MICROSOFT® INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE® FLASH® platform, JAVASCRIPT® programming language, JAVA® programming language, application programming interfaces (APis), etc. In some embodiments, computer system 702 may implement a mail server 738 stored program component. Mail server 738 may be an Internet mail server such as MICROSOFT® EXCHANGE® mail server, or the like. Mail server 738 may utilize facilities such as ASP, ActiveX, ANSI C++/C#, MICROSOFT .NET® programming language, CGI scripts, JAVA® programming language, JAVASCRIPT® programming language, PERL® programming language, PHP® programming language, PYTHON® programming language, WebObjects, etc. Mail server 738 may utilize communication protocols such as internet message access protocol (IMAP), messaging application programming interface (MAPI), Microsoft Exchange, post office protocol (POP), simple mail transfer protocol (SMTP), or the like. In some embodiments, computer system 702 may implement a mail client 740 stored program component. Mail client 740 may be a mail viewing application, such as APPLE MAIL® mail client, MICROSOFT ENTOURAGE® mail client, MICROSOFT OUTLOOK® mail client, MOZILLA THUNDERBIRD® mail client, etc.

In some embodiments, computer system 702 may store user/application data 742, such as the data, variables, records, etc. as described in this disclosure. Such databases may be implemented as fault-tolerant, relational, scalable, secure databases such as ORACLE® database OR SYBASE® database. Alternatively, such databases may be implemented using standardized data structures, such as an array, hash, linked list, struct, structured text file (e.g., XML), table, or as object-oriented databases (e.g., using OBJECTSTORE® object database, POET® object database, ZOPE® object database, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Various embodiments of the invention provide method and device for automatically generating personalized smart contracts. The method and device provide an asset owner with recommended smart contract templates that the asset owner can use to make the asset more intelligent. This further enables the asset with more autonomy to respond to various events. The invention provides multiple advantages to asset owners, OEM, dealers or any stakeholder associated with the asset to create a Gig Economy for the machines to maximize asset utilization potential, increase efficiency in the way assets collaborate with service providers, enable a trustful environment in the way businesses are executed, thereby making assets completely independent and intelligent.

Blockchain and IoT have become a hot topic now across the nations and Gig Economy trend, as a service model, is catching up with almost every other nation. When the solution addresses global challenges like sustainable innovation, re-use, share, maximizing asset utilization potential, the provided solution is a must need for countries that support the “as-a-service” model.

The specification has described method and device for automatically generating personalized smart contracts. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fail within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for automatically generating personalized smart contracts comprises:
identifying, by a smart contract creating device, a plurality of asset attributes associated with a current asset within a blockchain network;
comparing, by the smart contract creating device, each of the plurality of asset attributes with each of a plurality of asset clusters to compute a cluster similarity score for each of the plurality of asset clusters, when a plurality of assets within the blockchain network do not comprise the current asset, wherein each asset cluster within the plurality of asset clusters comprises a set of assets from the plurality of assets, and wherein each of the plurality of assets comprises an associated smart contract template;
identifying, by the smart contract creating device, an asset cluster from the plurality of asset clusters, wherein the cluster similarity score for the asset cluster is the highest and is above a predefined threshold;
computing, by the smart contract creating device, similarity scores for each of the set of assets within the asset cluster, based on a comparison with the plurality of asset attributes of the current asset;
identifying, by the smart contract creating device, at least one asset from he set of assets based on the associated similarity scores; and
generating, by the smart contract creating device, a current smart contract template based on at least one smart contract template associated with the at least one asset.

2. The method of claim 1, wherein the plurality of asset attributes associated with the current asset comprise at least one of a make of the asset, a model of the asset, an asset category associated with the asset, rental rates associated with the asset, utilization of the asset, maximum speed associated with the asset, maximum Rounds Per Minute (RPM) associated with the asset, number of cycles associated with the asset, and a location of the asset.

3. The method of claim 1 further comprises creating the plurality of asset clusters based on the plurality of asset attributes of the current asset.

4. The method of claim 1 further comprises creating the plurality of asset clusters based on asset attributes associated with the plurality of assets.

5. The method of claim 1, wherein identifying the at least one asset comprises:
assigning a rank to each asset in the set of assets within the asset cluster based on the associated similarity scores; and
selecting the at least one asset from the set of assets, wherein the rank associated with the at least one asset is greater than a predefined threshold rank.

6. The method of claim 1, further comprises:
identifying a smart contract template based on an asset domain ontology, when the plurality of assets within the blockchain network comprise the current asset, wherein the asset domain ontology comprises an ontology tree for he plurality of assets and associated smart contract templates; and
generating a smart contract for the current asset, based on the identified smart contract template.

7. The method of claim 1 further comprises:
processing a plurality of contract documents created in natural language associated with the plurality of assets, when the cluster similarity scores for each of the plurality of asset clusters is equal to or below the predefined threshold; and
performing Natural Language Processing (NLP) based on an Artificial Intelligence (AI) model to generate a smart contract template for the current asset, in response to the processing.

8. The method of claim 1 further comprises:
receiving a plurality of details from a stakeholder and the plurality of asset attributes from the current asset; and
extracting a context and a plurality of features from the plurality of details received from the stakeholder and the plurality of asset attributes received from the current asset.

9. The method of claim 8 further comprises populating the current smart contract template based on the context and the plurality of features to generate a current smart contract for the current asset.

10. An smart contract creating device for automatically generating personalized smart contracts, the smart contract creating device comprising:
a processor; and
a memory communicatively coupled to the processor, wherein the memory stores processor instructions, which, on execution, causes the processor to:
identify a plurality of asset attributes associated with a current asset within a blockchain network;
compare each of the plurality of asset attributes with each of a plurality of asset clusters to compute a cluster similarity score for each of the plurality of asset clusters, when a plurality of assets within the blockchain network do not comprise the current asset, wherein each asset cluster within the plurality of asset clusters comprises a set of assets from the plurality of assets, and wherein each of the plurality of assets comprises an associated smart contract template;
identify an asset cluster from the plurality of asset clusters, wherein the cluster similarity score for the asset cluster is the highest and is above a predefined threshold;
compute similarity scores for each of the set of assets within the asset cluster, based on a comparison with the plurality of asset attributes of the current asset;
identify at least one asset from the set of assets based on the associated similarity scores; and
generate a current smart contract template based on at least one smart contract template associated with the at least one asset.

11. The smart contract creating device of claim 10, wherein the plurality of asset attributes associated with the current asset comprise at least one of a make of the asset, a model of the asset, an asset category associated with the asset, rental rates associated with the asset, utilization of the asset, maximum speed associated with the asset, maximum Rounds Per Minute (RPM) associated with the asset, number of cycles associated with the asset, and a location of the asset.

12. The smart contract creating device of claim 10, wherein the processor instructions further cause the processor to create the plurality of asset clusters based on the plurality of asset attributes of the current asset.

13. The smart contract creating device of claim 10, wherein the processor instructions further cause the processor to create the plurality of asset clusters based on asset attributes associated with the plurality of assets.

14. The smart contract creating device of claim 10, wherein to identifying the at least one asset the processor instructions further cause the processor to:
assign a rank to each asset in the set of assets within the asset cluster based on the associated similarity scores; and
select the at least one asset from the set of assets, wherein the rank associated with the at least one asset is greater than a predefined threshold rank.

15. The smart contract creating device of claim 10, wherein the processor instructions further cause the processor to:
identify a smart contract template based on an asset domain ontology, when the plurality of assets within the blockchain network comprise the current asset, wherein the asset domain ontology comprises an ontology tree for the plurality of assets and associated smart contract templates; and
generate a smart contract for the current asset, based on the identified smart contract template.

16. The smart contract creating device of claim 10, wherein the processor instructions further cause the processor to:
process a plurality of contract documents created in natural language associated with the plurality of assets, when the cluster similarity scores for each of the plurality of asset clusters is equal to or below the predefined threshold; and
perform Natural Language Processing (NLP) based on an Artificial Intelligence (AI) model to generate a smart contract template for the current asset, in response to the processing.

17. The smart contract creating device of claim 10, wherein the processor instructions further cause the processor to:
receive a plurality of details from a stakeholder and the plurality of asset attributes from the current asset; and
extract a context and a plurality of features from the plurality of details received from the stakeholder and the plurality of asset attributes received from the current asset.

18. The smart contract creating device of claim 17, wherein the processor instructions further cause the processor to populate the current smart contract template based on the context and the plurality of features to generate a current smart contract for the current asset.

19. A non-transitory computer-readable storage medium having stored thereon, a set of computer-executable instructions causing a computer comprising one or more processors to perform steps comprising:
identifying a plurality of asset attributes associated with a current asset within a blockchain network;
comparing each of the plurality of asset attributes with each of a plurality of asset clusters to compute a cluster similarity score for each of the plurality of asset clusters, when a plurality of assets within the blockchain network do not comprise the current asset, wherein each asset cluster within the plurality of asset clusters comprises a set of assets from the plurality of assets, and wherein each of the plurality of assets comprises an associated smart contract template;
identifying an asset cluster from the plurality of asset clusters, wherein the cluster similarity score for the asset cluster is the highest and is above a predefined threshold;
computing similarity scores for each of the set of assets within the asset cluster, based on a comparison with the plurality of asset attributes of the current asset;
identifying at least one asset from the set of assets based on the associated similarity scores; and
generating a current smart contract template based on at least one smart contract template associated with the at least one asset.
